(19) United States
(12) Patent Application Publication
(10) Pub. No.: US 2012/0298086 A1
(43) Pub. Date: Nov. 29, 2012

(54) FUEL DELIVERY SYSTEM FOR NATURAL GAS SPLIT-CYCLE ENGINE

(75) Inventor: Salvatore C. Scuderi, Westfield, MA (US)

(73) Assignee: SCUDERI GROUP, LLC, 01089, MA (US)

(21) Appl. No.: 13/477,369

(22) Filed: May 22, 2012

Related U.S. Application Data
(60) Provisional application No. 61/489,556, filed on May 24, 2011.

(51) Int. Cl. F02B 33/22

(52) U.S. Cl. 123/70 R

(57) ABSTRACT

Methods, systems, and devices are disclosed that generally involve split-cycle engines in which natural gas, and in particular natural gas supplied from a low pressure source, is used as the fuel for combustion. In one embodiment, natural gas is supplied directly to the expansion cylinder via a gas inlet valve just before and/or just after the expansion piston reaches top dead center, when the pressure within the expansion cylinder is relatively low. A crossover expansion valve is then opened to distribute the natural gas in the expansion cylinder and mix it with high pressure air from a crossover passage before ignition during a power stroke. Natural gas split-cycle air hybrid engines are also disclosed.

### CROSS-REFERENCE TO RELATED APPLICATIONS

This application claims the benefit of priority of U.S. Provisional Patent Application No. 61/489,556, filed on May 24, 2011, the entire contents of which are incorporated herein by reference.

### FIELD

The present invention relates to internal combustion engines. More particularly, the invention relates to fuel delivery systems for natural gas split-cycle engines.

### BACKGROUND

For purposes of clarity, the term “conventional engine” as used in the present application refers to an internal combustion engine wherein all four strokes of the well-known Otto cycle (the intake, compression, expansion and exhaust strokes) are contained in each piston/cylinder combination of the engine. Each stroke requires one half revolution of the crankshaft (180 degrees crank angle (“CA”)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine generally comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

A split-cycle air hybrid engine combines a split-cycle engine with an air reservoir (also commonly referred to as an air tank) and various controls. This combination enables the engine to store energy in the form of compressed air in the air reservoir. The compressed air in the air reservoir is later used in the expansion cylinder to power the crankshaft. In general, a split-cycle air hybrid engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft;

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween; and

an air reservoir operatively connected to the crossover passage and selectively operable to store compressed air from the compression cylinder and to deliver compressed air to the expansion cylinder.

FIG. 1 illustrates one exemplary embodiment of a prior art split-cycle air hybrid engine. The split-cycle engine 100 replaces two adjacent cylinders of a conventional engine with a combination of one compression cylinder 102 and one expansion cylinder 104. The compression cylinder 102 and the expansion cylinder 104 are formed in an engine block in which a crankshaft 106 is rotatably mounted. Upper ends of the cylinders 102, 104 are closed by a cylinder head 130. The crankshaft 106 includes axially displaced and angularly offset first and second crank throws 126, 128, having a phase angle therebetween. The first crank throw 126 is pivotally joined by a first connecting rod 138 to a compression piston 110 and the second crank throw 128 is pivotally joined by a second connecting rod 140 to an expansion piston 120 to reciprocate the pistons 110, 120 in their respective cylinders 102, 104 in a timed relation determined by the angular offset of the crank throws and the geometric relationships of the cylinders, crank, and pistons. Alternative mechanisms for relating the motion and timing of the pistons can be utilized if desired. The rotational direction of the crankshaft and the relative motions of the pistons near their bottom dead center (BDC) positions are indicated by the arrows associated in the drawings with their corresponding components.

The four strokes of the Otto cycle are thus “split” over the two cylinders 102 and 104 such that the compression cylinder 102 contains the intake and compression strokes and the expansion cylinder 104 contains the expansion and exhaust strokes. The Otto cycle is therefore completed in these two cylinders 102, 104 once per crankshaft 106 revolution (360 degrees CA).

During the intake stroke, intake air is drawn into the compression cylinder 102 through an inwardly-opening (opening inward into the cylinder and toward the piston) poppet intake valve 108. During the compression stroke, the compression piston 110 pressurizes the air charge and drives the air charge through a crossover passage 112, which acts as the intake passage for the expansion cylinder 104. The engine 100 can have one or more crossover passages 112.

The volumetric (or geometric) compression ratio of the compression cylinder 102 of the split-cycle engine 100 (and for split-cycle engines in general) is herein referred to as the “compression ratio” of the split-cycle engine. The volumetric (or geometric) compression ratio of the expansion cylinder 104 of the engine 100 (and for split-cycle engines in general) is herein referred to as the “expansion ratio” of the split-cycle engine. The volumetric compression ratio of a cylinder is well known in the art as the ratio of the enclosed (or trapped) volume in the cylinder (including all recesses) when a piston reciprocating therein is at its BDC position to the enclosed volume (i.e., clearance volume) in the cylinder when said piston is at its top dead center (TDC) position. Specifically for split-cycle engines as defined herein, the compression ratio of a compression cylinder is determined when the XovrC valve is closed. Also specifically for split-cycle engines as defined herein, the expansion ratio of an expansion cylinder is determined when the XovrE valve is closed.

Due to very high volumetric compression ratios (e.g., 20 to 1, 30 to 1, 40 to 1, or greater) within the compression cylinder 102, an outwardly-opening (opening outwardly away from the cylinder and piston) poppet crossover compression (XovrC) valve 114 at the inlet of the crossover passage 112 is used to control flow from the compression cylinder 102 into the crossover passage 112. Due to very high volumetric compression ratios (e.g., 20 to 1, 30 to 1, 40 to 1, or greater) within the expansion cylinder 104, an outwardly-opening poppet crossover expansion (XovrE) valve 116 at the outlet of the crossover passage 112 controls flow from the crossover passage 112 into the expansion cylinder 104. The actuation rates and phasing of the XovrC and XovrE valves 114, 116 are timed to maintain pressure in the crossover passage 112 at a high minimum pressure (typically 20 bar or higher at full load) during all four strokes of the Otto cycle.

At least one fuel injector 118 injects fuel into the pressurized air at the exit end of the crossover passage 112 in coordination with the XovrE valve 116 opening. Alternatively, or in addition, fuel can be injected directly into the expansion cylinder 104. The fuel-air charge fully enters the expansion cylinder 104 shortly after the expansion piston 120 reaches its TDC position. As the piston 120 begins its descent from its TDC position, and while the XovrE valve 116 is still open, one or more spark plugs 122 are fired to initiate combustion (typically between 10 to 20 degrees CA after TDC of the expansion piston 120). Combustion can be initiated while the expansion piston is between 1 and 30 degrees CA past its TDC position. More preferably, combustion can be initiated while the expansion piston is between 5 and 25 degrees CA past its TDC position. Most preferably, combustion can be initiated while the expansion piston is between 10 and 20 degrees CA past its TDC position. Additionally, combustion can be initiated through other ignition devices and/or methods, such as with glow plugs, microwave ignition devices, or through compression ignition methods.

The XovrE valve 116 is then closed before the resulting combustion event enters the crossover passage 112. The combustion event drives the expansion piston 120 downward in a power stroke. Exhaust gases are pumped out of the expansion cylinder 104 through an inwardly-opening poppet exhaust valve 124 during the exhaust stroke.

With the split-cycle engine concept, the geometric engine parameters (i.e., bore, stroke, connecting rod length, compression ratio, etc.) of the compression and expansion cylinders are generally independent from one another. For example, the crank throws 126, 128 for the compression cylinder 102 and expansion cylinder 104, respectively, have different radii and are phased apart from one another with TDC of the expansion piston 120 occurring prior to TDC of the compression piston 110. This independence enables the split-cycle engine to potentially achieve higher efficiency levels and greater torques than typical four-stroke engines.

The geometric independence of engine parameters in the split-cycle engine 100 is also one of the main reasons why pressure can be maintained in the crossover passage 112 as discussed earlier. Specifically, the expansion piston 120 reaches its TDC position prior to the compression piston 110 reaching its TDC position by a discrete phase angle (typically between 10 and 30 crank angle degrees). This phase angle, together with proper timing of the XovrC valve 114 and the XovrE valve 116, enables the split-cycle engine 100 to maintain pressure in the crossover passage 112 at a high minimum pressure (typically 20 bar absolute or higher during full load operation) during all four strokes of its pressure/volume cycle. That is, the split-cycle engine 100 is operable to time the XovrC valve 114 and the XovrE valve 116 such that the XovrC and XovrE valves 114, 116 are both open for a substantial period of time (or period of crankshaft rotation) during which the expansion piston 120 descends from its TDC position towards its BDC position and the compression piston 110 simultaneously ascends from its BDC position towards its TDC position. During the period of time (or crankshaft rotation) that the crossover valves 114, 116 are both open, a substantially equal mass of gas is transferred (1) from the compression cylinder 102 into the crossover passage 112 and (2) from the crossover passage 112 to the expansion cylinder 104. Accordingly, during this period, the pressure in the crossover passage is prevented from dropping below a predetermined minimum pressure (typically 20, 30, or 40 bar absolute during full load operation). Moreover, during a substantial portion of the intake and exhaust strokes (typically 90% of the entire intake and exhaust strokes or greater), the XovrC valve 114 and XovrE valve 116 are both closed to maintain the mass of trapped gas in the crossover passage 112 at a substantially constant level. As a result, the pressure in the crossover passage 112 is maintained at a predetermined minimum pressure during all four strokes of the engine's pressure/volume cycle.

For purposes herein, the method of opening the XovrC 114 and XovrE 116 valves while the expansion piston 120 is descending from TDC and the compression piston 110 is ascending toward TDC in order to simultaneously transfer a substantially equal mass of gas into and out of the crossover passage 112 is referred to as the “push-pull” method of gas transfer. It is the push-pull method that enables the pressure in the crossover passage 112 of the engine 100 to be maintained at typically 20 bar or higher during all four strokes of the engine's cycle when the engine is operating at full load.

The crossover valves 114, 116 are actuated by a valve train that includes one or more cams (not shown). In general, a cam-driven mechanism includes a camshaft mechanically linked to the crankshaft. One or more cams are mounted to the camshaft, each having a contoured surface that controls the valve lift profile of the valve event (i.e., the event that occurs during a valve actuation). The XovrC valve 114 and the XovrE valve 116 each can have its own respective cam and/or its own respective camshaft. As the XovrC and XovrE cams rotate, eccentric portions thereof impart motion to a rocker arm, which in turn imparts motion to the valve, thereby lifting (opening) the valve off of its valve seat. As the cam continues to rotate, the eccentric portion passes the rocker arm and the valve is allowed to close.

For purposes herein, a valve event (or valve opening event) is defined as the valve lift from its initial opening off of its valve seat to its closing back onto its valve seat versus rotation of the crankshaft during which the valve lift occurs. Also, for purposes herein, the valve event rate (i.e., the valve actuation rate) is the duration in time required for the valve event to occur within a given engine cycle. It is important to note that a valve event is generally only a fraction of the total duration of an engine operating cycle (e.g., 720 degrees CA for a conventional engine cycle and 360 degrees CA for a split-cycle engine).

The split-cycle air hybrid engine 100 also includes an air reservoir (tank) 142, which is operatively connected to the crossover passage 112 by an air reservoir tank valve 152. Embodiments with two or more crossover passages 112 may include a tank valve 152 for each crossover passage 112, which connect to a common air reservoir 142, or alternatively each crossover passage 112 may operatively connect to separate air reservoirs 142.

The tank valve 152 is typically disposed in an air tank port 154, which extends from the crossover passage 112 to the air tank 142. The air tank port 154 is divided into a first air tank port section 156 and a second air tank port section 158. The first air tank port section 156 connects the air tank valve 152 to the crossover passage 112, and the second air tank port section 158 connects the air tank valve 152 to the air tank 142. The volume of the first air tank port section 156 includes the volume of all additional recesses which connect the tank valve 152 to the crossover passage 112 when the tank valve 152 is closed. Preferably, the volume of the first air tank port section 156 is small relative to the second air tank port section 158. More preferably, the first air tank port section 156 is substantially non-existent, that is, the tank valve 152 is most preferably disposed such that it is flush against the outer wall of the crossover passage 112.

The tank valve 152 may be any suitable valve device or system. For example, the tank valve 152 may be a pressure activated check valve, or an active valve which is activated by various valve actuation devices (e.g., pneumatic, hydraulic, cam, electric, or the like). Additionally, the tank valve 152 may comprise a tank valve system with two or more valves actuated with two or more actuation devices.

The air tank 142 is utilized to store energy in the form of compressed air and to later use that compressed air to power the crankshaft 106. This mechanical means for storing potential energy provides numerous potential advantages over the current state of the art. For instance, the split-cycle air hybrid engine 100 can potentially provide many advantages in fuel efficiency gains and NOx emissions reduction at relatively low manufacturing and waste disposal costs in relation to other technologies on the market, such as diesel engines and electric-hybrid systems.

The engine 100 typically runs in a normal operating or firing (NF) mode (also commonly called the engine firing (EF) mode) and one or more of four basic air hybrid modes. In the EF mode, the engine 100 functions normally as previously described in detail herein, operating without the use of the air tank 142. In the EF mode, the air tank valve 152 remains closed to isolate the air tank 142 from the basic split-cycle engine. In the four air hybrid modes, the engine 100 operates with the use of the air tank 142.

The four basic air hybrid modes include:

1) Air Expander (AE) mode, which includes using compressed air energy from the air tank 142 without combustion;

2) Air Compressor (AC) mode, which includes storing compressed air energy into the air tank 142 without combustion;

3) Air Expander and Firing (AEF) mode, which includes using compressed air energy from the air tank 142 with combustion; and

4) Firing and Charging (FC) mode, which includes storing compressed air energy into the air tank 142 with combustion.

Further details on split-cycle engines can be found in U.S. Pat. No. 6,543,225 entitled Split Four Stroke Cycle Internal Combustion Engine and issued on Apr. 8, 2003; and U.S. Pat. No. 6,952,923 entitled Split-Cycle Four-Stroke Engine and issued on Oct. 11, 2005, each of which is incorporated by reference herein in its entirety.

Further details on air hybrid engines are disclosed in U.S. Pat. No. 7,353,786 entitled Split-Cycle Air Hybrid Engine and issued on Apr. 8, 2008; U.S. Patent Application No. 61/365,343 entitled Split-Cycle Air Hybrid Engine and filed on Jul. 18, 2010; and U.S. Patent Application No. 61/313,831 entitled Split-Cycle Air Hybrid Engine and filed on Mar. 15, 2010, each of which is incorporated by reference herein in its entirety.

Natural gas is commonly used as fuel in powering internal combustion engines. The term “natural gas” as used herein includes natural gas in its traditional form as well as compressed natural gas (“CNG”), liquefied natural gas (“LNG”), and adsorbed natural gas (“ANG”). Natural gas is generally considered to be a “clean” fuel, since it produces less carbon dioxide per unit of energy than most other fossil fuels such as gasoline and diesel. In addition, natural gas has a higher octane number than gasoline or diesel and thus supports higher compression ratios with less susceptibility to pre-ignition.

In mobile applications (e.g., automobile or other vehicle engines), natural gas is typically stored in a tank or cylinder and is supplied to the engine via one or more fuel lines. In these applications, CNG is typically stored at about 205 to 275 bar and at or just above ambient temperature in a reinforced cylinder. LNG is typically stored at about 0 to 2.1 bar at a very low temperature (e.g., −162 degrees C.) in a vacuum-insulated storage tank. ANG is typically stored at about 35 bar in a sponge-like material.

In stationary applications (e.g., generators), natural gas can also be supplied from a storage tank or cylinder but is typically supplied instead from a land-based source fed by a network of delivery infrastructure. In some cases, the natural gas is supplied from a refining or processing plant to a plurality of major transmission lines, where it is distributed geographically at a pressure of anywhere between about 10 and 100 bar. This distribution pressure is usually reduced to between about 0.01 and 10 bar before being brought into homes, businesses, etc. In order to isolate natural gas engines from pressure fluctuations in the supply system, the natural gas that is fed to the engine is typically regulated to a pressure that is set near the lower end of this spectrum.

Accordingly, natural gas internal combustion engines, and particularly those that operate using LNG or a land-based source, whether in mobile or stationary applications, must support operation with a relatively low-pressure supply of natural gas. This low-pressure constraint makes it difficult to operate split-cycle engines of the type illustrated in FIG. 1 efficiently using natural gas. In particular, the high pressure maintained within the crossover passage prevents effective addition of fuel to the crossover passage unless the fuel is supplied at a pressure that is equal to or greater than the crossover passage pressure. Accordingly, there is a need for improved natural gas split-cycle engines and/or associated fuel delivery systems.

### SUMMARY

The methods, systems, and devices disclosed herein generally involve split-cycle engines in which natural gas, and in particular natural gas supplied from a low pressure source, is used as the fuel for combustion. In one embodiment, natural gas is supplied directly to the expansion cylinder via a gas inlet valve just before and/or just after the expansion piston reaches top dead center, when the pressure within the expansion cylinder is relatively low. A crossover expansion valve is then opened to distribute the natural gas in the expansion cylinder and mix it with high pressure air from a crossover passage before ignition during a power stroke. Natural gas split-cycle air hybrid engines are also disclosed.

In one aspect of at least one embodiment of the invention, an engine is provided that includes a crankshaft rotatable about a crankshaft axis, a compression piston slidably received within a compression cylinder and operatively connected to the crankshaft such that the compression piston reciprocates through an intake stroke and a compression stroke during a single rotation of the crankshaft, and an expansion piston slidably received within an expansion cylinder and operatively connected to the crankshaft such that the expansion piston reciprocates through an expansion stroke and an exhaust stroke during a single rotation of the crankshaft. The engine also includes a crossover passage interconnecting the compression and expansion cylinders, the crossover passage including at least a crossover expansion valve disposed therein. The engine also includes at least one gas inlet valve configured to selectively place a source of natural gas in fluid communication with the expansion cylinder.

Related aspects of the invention provide an engine, e.g., as described above, in which the crossover passage further comprises a crossover compression valve, the crossover compression and crossover expansion valves defining a pressure chamber therebetween.

Related aspects of the invention provide an engine, e.g., as described above, that includes an air reservoir operatively connected to the crossover passage and selectively operable to store compressed air from the compression cylinder and to deliver compressed air to the expansion cylinder.

Related aspects of the invention provide an engine, e.g., as described above, that includes a venturi having first and second inlets and at least one outlet, the first inlet being coupled to the crossover passage via an air conduit, the second inlet being coupled to the source of natural gas, and the at least one outlet being coupled to the expansion cylinder via the gas inlet valve.

In another aspect of at least one embodiment of the invention, a method of operating a split-cycle engine is provided that includes, after an expansion piston reaches its top dead center position within an expansion cylinder, opening a gas inlet valve to supply natural gas to the expansion cylinder. The method also includes closing the gas inlet valve after a desired amount of natural gas is supplied to the expansion cylinder and opening a crossover expansion valve to place the expansion cylinder in fluid communication with a crossover passage such that pressurized air flows from the crossover passage into the expansion cylinder. The method also includes igniting a mixture of the natural gas and the pressurized air in the expansion cylinder to drive the expansion piston downwards in a power stroke.

Related aspects of the invention provide a method, e.g., as described above, that includes closing the crossover expansion valve before igniting the mixture.

Related aspects of the invention provide a method, e.g., as described above, that includes closing the crossover expansion valve after igniting the mixture.

In another aspect of at least one embodiment of the invention, a method of operating a split-cycle engine is provided that includes, before an expansion piston reaches its top dead center position within an expansion cylinder, opening a gas inlet valve to supply natural gas to the expansion cylinder. The method also includes closing the gas inlet valve after a desired amount of natural gas is supplied to the expansion cylinder and opening a crossover expansion valve to place the expansion cylinder in fluid communication with a crossover passage such that pressurized air flows from the crossover passage into the expansion cylinder. The method also includes igniting a mixture of the natural gas and the pressurized air in the expansion cylinder to drive the expansion piston downwards in a power stroke.

Related aspects of the invention provide a method, e.g., as described above, that includes closing the crossover expansion valve before igniting the mixture.

Related aspects of the invention provide a method, e.g., as described above, that includes closing the crossover expansion valve after igniting the mixture.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1 is a schematic diagram of a prior art split-cycle air hybrid engine;

FIG. 2 is a schematic diagram of one exemplary embodiment of a natural gas split-cycle engine;

FIG. 3 is a schematic diagram of another exemplary embodiment of a natural gas split-cycle engine; and

FIG. 4 is a schematic diagram of one exemplary embodiment of a natural gas split-cycle air hybrid engine.

### DETAILED DESCRIPTION

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The term “air” is used herein to refer both to air and mixtures of air and other substances such as fuel or exhaust products. The term “fluid” is used herein to refer to both liquids and gasses. Features shown in a particular figure that are the same as, or similar to, features shown in another figure are designated by like reference numerals.

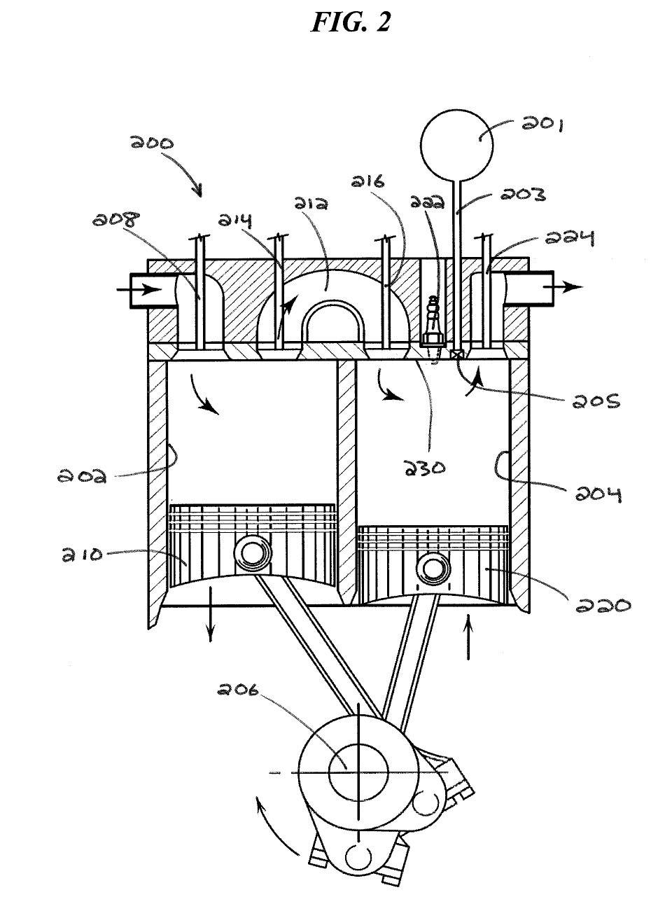

FIG. 2 illustrates one exemplary embodiment of a natural gas split-cycle engine 200. Natural gas is provided from a gas supply 201 (e.g., a land-based source or a storage tank) and is supplied to the engine via at least one gas supply line 203. The at least one gas supply line 203 optionally routes the natural gas through a pressure regulator (not shown), which effectively isolates the engine 200 from pressure fluctuations that may occur in the gas supply 201. The resulting regulated supply of natural gas is selectively placed in fluid communication with the expansion cylinder 204 of the engine via a gas inlet valve 205. The gas inlet valve 205 can be inwardly-opening (e.g., opening into the expansion cylinder 204 towards the expansion piston 220) such that when the valve 205 is held closed against its valve seat, the valve seat provides a positive mechanical stop when the valve 205 is subjected to the immense pressures of combustion in the expansion cylinder 204. It will be appreciated that more than one gas inlet valve 205 can be provided within the expansion cylinder 204, and can be coupled to the same or a different supply of natural gas.

In operation, the intake valve 208 is opened during an intake stroke to allow the descending compression piston 210 to draw air into the compression cylinder 202. During a subsequent compression stroke, the compression piston 210 ascends within the compression cylinder 202 while the crossover compression valve 214 is held open and the intake valve 208 is closed to compress the air contained within the compression cylinder 202 into the crossover passage 212.

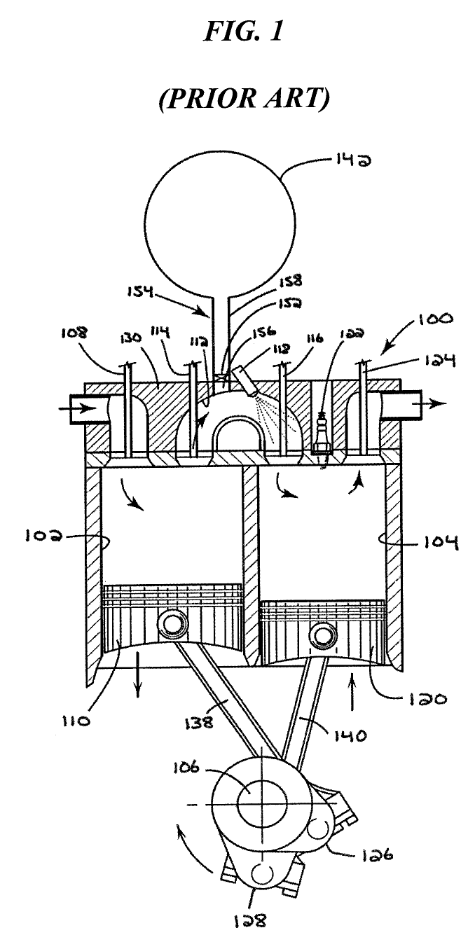

Meanwhile, the crossover expansion valve 216 remains closed as the expansion piston 220 ascends towards its TDC position during an exhaust stroke. The exhaust valve 224 is open during this time to allow combustion products from a previous cycle to be routed into the engine's exhaust system. As the expansion piston 220 approaches TDC, or shortly after the expansion piston 220 reaches TDC, the gas inlet valve 205 is opened to supply natural gas to the expansion cylinder 204. Unlike the engine 100 of FIG. 1, in which fuel is injected into the crossover passage 112, the engine 200 is configured to supply fuel directly to the expansion cylinder 204. The pressure within the expansion cylinder 204 at this time is relatively low compared to the pressure within the crossover passage 212, thus allowing the low pressure natural gas to enter the expansion cylinder 204. The gas inlet valve 205 can be opened before closing the exhaust valve 224, in which case the supplied natural gas can be used to help purge any remaining combustion products from the expansion cylinder 204, or it can be opened after the exhaust valve 224 is closed.

In embodiments in which the gas inlet valve 205 is opened before the expansion piston 220 reaches TDC, the gas inlet valve 205 can be an outwardly-opening (e.g., opening out away from the expansion piston 220) poppet valve. Opening the gas inlet valve 205 before the expansion piston 220 reaches TDC can advantageously increase the window of time during which fuel can be added, thereby increasing the total amount of fuel that can be added in a given cycle. The timing at which the gas inlet valve 205 is opened in such embodiments can be controlled to avoid adding too much gas before TDC, which can undesirably result in pre-ignition due to the very low clearance space between the expansion piston 220 and the cylinder head 230 when the expansion piston 220 reaches TDC. The gas inlet valve 205 can then remain open after the expansion piston 220 reaches TDC and begins its descent to continue supplying fuel to the expansion cylinder 204.

Once the desired amount of fuel is added, the gas inlet valve 205 is closed to isolate the gas supply 201 from the expansion cylinder 204. Shortly before the gas inlet valve 205 is closed, or shortly after the gas inlet valve 205 is closed, the crossover expansion valve 216 is opened to allow compressed air in the crossover passage 212 to flow at high speed (optionally reaching sonic flow) from the crossover passage 212 into the expansion cylinder 204, thereby creating turbulent flow, distributing the natural gas within the cylinder 204, and exerting a downward force on the face of the expansion piston 220. Either shortly before the crossover expansion valve 216 is closed, simultaneously with the crossover expansion valve 216 closing, or shortly after closing the crossover expansion valve 216, one or more spark plugs 222 disposed within the expansion cylinder 204 are fired to ignite the air/fuel mixture contained therein. The resulting combustion pressure, coupled with the pressure supplied from the crossover passage 212, drives the expansion piston 220 downwards in a power stroke, thereby imparting a rotational force to the crankshaft 206. The expansion piston 220 then ascends once again within the expansion cylinder 204 during an exhaust stroke to purge combustion products from the expansion cylinder 204, after which the cycle repeats.

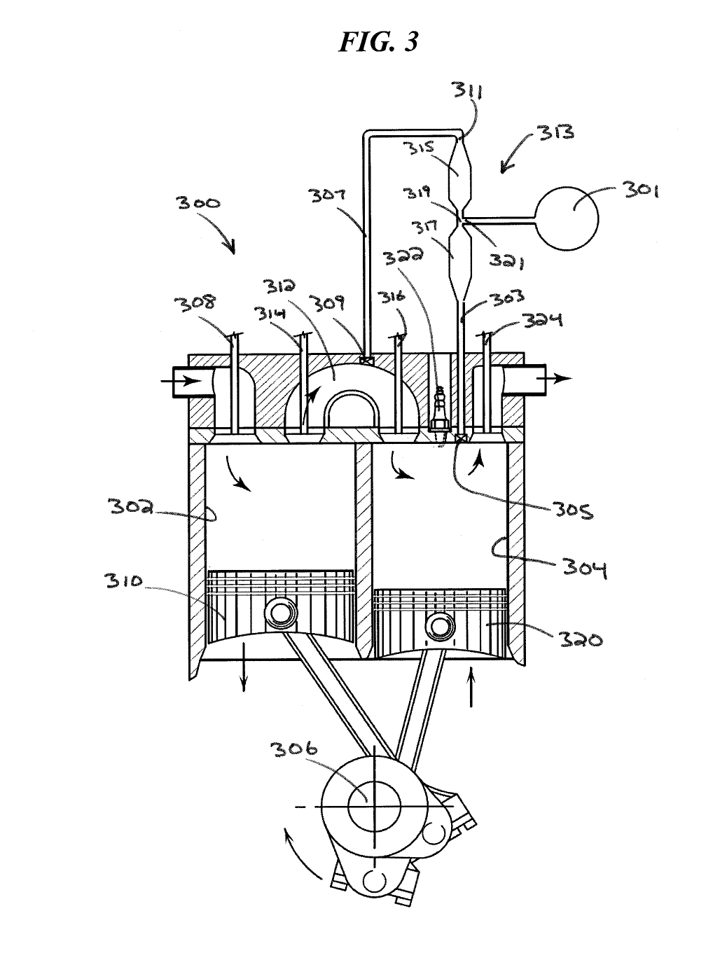

FIG. 3 illustrates another exemplary embodiment of a natural gas split-cycle engine 300. The engine includes an air conduit 307 and an air conduit control valve 309 that are configured to selectively supply air from the crossover passage 312 to a first inlet 311 of a venturi 313. The venturi 313 includes first and second increased-diameter chambers 315, 317 coupled to one another by an intermediate reduced-diameter neck 319. A gas supply 301 is coupled to the neck 319 via a second inlet orifice 321 of the venturi 313. When high pressure air from the crossover passage 312 passes from the first chamber 315 to the neck portion 319 of the venturi 313, its velocity increases with a corresponding drop in pressure. This drop in pressure sucks natural gas from the gas supply 301 into the venturi 313 and mixes it with the air flowing from the crossover passage 312. The air/gas mixture then flows into the second increased-diameter chamber 317 of the venturi 313, where its pressure is substantially restored and its velocity decreased before being fed through the gas supply line 303 and entering the expansion cylinder 304 via the gas inlet valve 305. This configuration advantageously increases the window of time during which natural gas from a low pressure source can be added to the expansion cylinder 304, since the gas is actively drawn into the engine 300 by the venturi 313 and thus can still be added to the expansion cylinder 304 even when the pressure therein slightly exceeds that of the natural gas supply 301. The features and operation of the engine 300 of FIG. 3 are otherwise substantially identical to those of the engine 200 of FIG. 2.

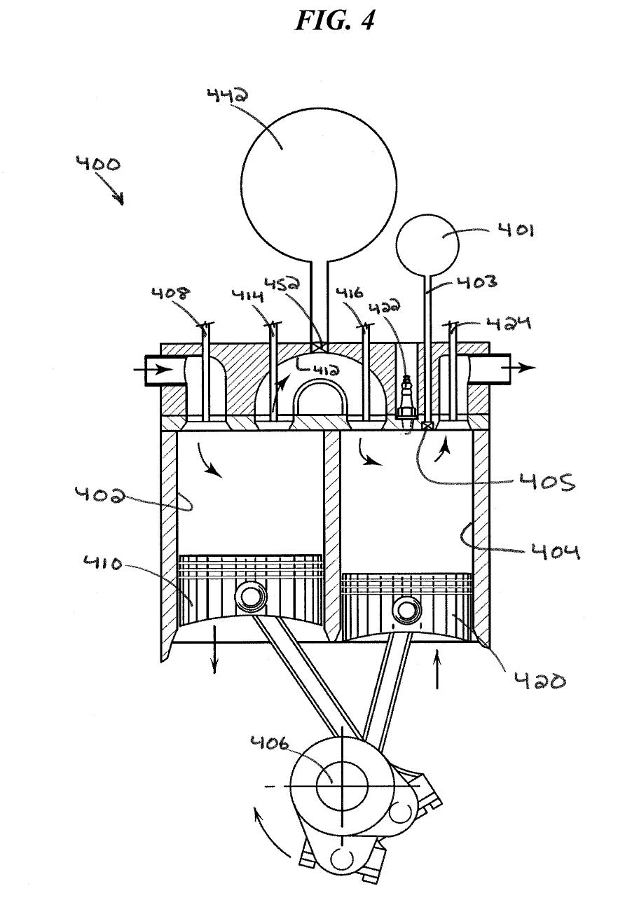

It will be appreciated that the concepts and features described above with respect to the engines 200, 300 can be readily adapted to a natural gas split-cycle air hybrid engine. For example, as shown in FIG. 4, an engine 400 substantially identical to the engine 200 of FIG. 2 can be provided with an air tank 442 that is operatively connected to the crossover passage 412 by an air tank valve 452. The air tank 442 is utilized to store energy in the form of compressed air and to later use that compressed air to power the crankshaft 406. In EF mode, the tank valve 452 remains closed to isolate the air tank 442 from the engine 400, and the engine 400 functions normally as described above with respect to FIG. 2.

In AE mode, fuel injection and combustion are disabled, and compressed air stored in the air tank 442 is supplied to the expansion cylinder 404 to drive the expansion piston 420 during the power stroke.

In one exemplary embodiment, the intake valve 408 is held open and the crossover compression valve 414 is held closed to idle the compression cylinder 402. The tank valve 452 is also held open to place the air tank 442 in fluid communication with the crossover passage 412. During each engine cycle, the crossover expansion valve 416 is opened just prior to and/or during the expansion stroke to supply compressed air from the air tank 442 and/or the crossover passage 412 to the expansion cylinder 404 and thereby exert a rotating force on the crankshaft 406. The crossover expansion valve 416 is closed once the desired amount of air is supplied to the expansion cylinder 404. The exhaust valve 424 is opened during the exhaust stroke such that the expansion piston 420 does not have to recompress the air in the expansion cylinder 404 as it ascends towards its TDC position for the next engine cycle. The cycle then repeats.

In AC mode, fuel injection and combustion are disabled, and air that is compressed in the compression cylinder 402 is supplied to the air tank 442 for storage.

In one exemplary embodiment, the intake valve 408 is opened and air is drawn into the compression cylinder 402 during the intake stroke. As the compression piston 410 ascends during the compression stroke, the crossover compression valve 414 and the tank valve 452 are opened while the intake valve 408 and the crossover expansion valve 416 are held closed such that the compression piston 410 compresses air into the air tank 442. The crossover expansion valve 416 remains closed and the exhaust valve 424 is held open during this time and during the expansion and exhaust strokes to idle the expansion cylinder 404. The cycle is then repeated.

In AEF mode, compressed air that was previously stored in the air tank 442 is used with combustion to drive the expansion piston 420.

In one exemplary embodiment, the intake valve 408 is held open and the crossover compression valve 414 is held closed to idle the compression cylinder 402. With the crossover expansion valve 416 closed, the air tank valve 452 is opened briefly to pressurize the crossover passage 412 with air stored in the air tank 442. The air tank valve 452 is then closed to isolate the air tank 442 from the forthcoming combustion event. Operation then proceeds as described above, with the gas inlet valve 405 opening shortly before or shortly after the expansion piston 420 reaches TDC to supply natural gas from the gas supply 401 to the expansion cylinder 404 via the gas supply line 403. The crossover expansion valve 416 is then opened to supply high pressure air to the expansion cylinder 404 and combustion is initiated to drive the expansion piston 420 downward and impart rotational force to the crankshaft 406. The exhaust valve 424 is opened during the exhaust stroke such that combustion products disposed within the expansion cylinder 404 are evacuated, after which the cycle repeats.

In FC mode, air compressed in the compression cylinder 402 is used both to charge the air tank 442 and to support combustion.

In one exemplary embodiment, the intake valve 408 is opened and the crossover compression valve 414 is closed during an intake stroke. During the subsequent compression stroke, the intake valve 408 and the crossover expansion valve 416 are held closed, while the crossover compression valve 414 and the air tank valve 452 are opened. This allows the compression piston 410 to compress the intake air charge into the crossover passage 412 and the air tank 442. With the crossover expansion valve 416 still in the closed position, the crossover compression valve 414 and the air tank valve 452 are then closed to seal the crossover passage 412. It will be appreciated that the timing of these valve closures can be controlled to meter the amount of air remaining in the crossover passage 412. In other words, the valve timing can be controlled to regulate the percentage of the compression charge that is added to the tank 442 versus the percentage of the compression charge that remains in the crossover passage 412 to support combustion. Operation then proceeds as described above, with the gas inlet valve 405 opening shortly before or shortly after the expansion piston 420 reaches TDC to supply natural gas from the gas supply line 401 to the expansion cylinder 404 via the gas supply line 403. The crossover expansion valve 416 is then opened to supply high pressure air to the expansion cylinder 404 and combustion is initiated to drive the expansion piston 420 downward and impart rotational force to the crankshaft 406. The exhaust valve 424 is opened during the exhaust stroke such that combustion products disposed within the expansion cylinder 404 are evacuated, after which the cycle repeats.

It will thus be appreciated that the concepts disclosed herein have application in both non-hybrid split-cycle engines and in air hybrid split-cycle engines.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. An engine comprising:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion piston slidably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including at least a crossover expansion valve disposed therein; and
at least one gas inlet valve configured to selectively place a source of natural gas in fluid communication with the expansion cylinder.

2. The engine of claim 1, wherein the crossover passage further comprises a crossover compression valve, the crossover compression and crossover expansion valves defining a pressure chamber therebetween.

3. The engine of claim 1, further comprising an air reservoir operatively connected to the crossover passage and selectively operable to store compressed air from the compression cylinder and to deliver compressed air to the expansion cylinder.

4. The engine of claim 1, further comprising a venturi having first and second inlets and at least one outlet, the first inlet being coupled to the crossover passage via an air conduit, the second inlet being coupled to the source of natural gas, and the at least one outlet being coupled to the expansion cylinder via the gas inlet valve.

5. A method of operating a split-cycle engine comprising:
after an expansion piston reaches its top dead center position within an expansion cylinder, opening a gas inlet valve to supply natural gas to the expansion cylinder;
closing the gas inlet valve after a desired amount of natural gas is supplied to the expansion cylinder;
opening a crossover expansion valve to place the expansion cylinder in fluid communication with a crossover passage such that pressurized air flows from the crossover passage into the expansion cylinder; and
igniting a mixture of the natural gas and the pressurized air in the expansion cylinder to drive the expansion piston downwards in a power stroke.

6. The method of claim 5, further comprising closing the crossover expansion valve before igniting the mixture.

7. The method of claim 5, further comprising closing the crossover expansion valve after igniting the mixture.

8. A method of operating a split-cycle engine comprising:
before an expansion piston reaches its top dead center position within an expansion cylinder, opening a gas inlet valve to supply natural gas to the expansion cylinder;
closing the gas inlet valve after a desired amount of natural gas is supplied to the expansion cylinder;
opening a crossover expansion valve to place the expansion cylinder in fluid communication with a crossover passage such that pressurized air flows from the crossover passage into the expansion cylinder; and
igniting a mixture of the natural gas and the pressurized air in the expansion cylinder to drive the expansion piston downwards in a power stroke.

9. The method of claim 8, further comprising closing the crossover expansion valve before igniting the mixture.

10. The method of claim 8, further comprising closing the crossover expansion valve after igniting the mixture.
